(19) United States
(12) Patent Application Publication
(10) Pub. No.: US 2018/0060980 A1
(43) Pub. Date: Mar. 1, 2018

(54) SEARCH WITH HOME TOUR NAVIGATION

(71) Applicant: Barbara Carey Stachowski, Orinda, CA (US)

(72) Inventor: Barbara Carey Stachowski, Orinda, CA (US)

(21) Appl. No.: 15/673,227

(22) Filed: Aug. 9, 2017

Related U.S. Application Data
(60) Provisional application No. 62/379,685, filed on Aug. 25, 2016.

(51) Int. Cl. G06Q 50/16; G06Q 40/06; G06Q 10/06

(52) U.S. Cl. CPC G06Q 50/163; G05B 2219/2642; G06Q 10/0631; G06Q 40/06

(57) ABSTRACT

A search with home tour navigation receives housing input (e.g., a user's housing preferences), calculates a route based on the selected/determined houses and displays the calculated route (e.g., a fastest route). The search with home tour navigation is able to factor in elements such as traffic, open house times, agent availability and/or any other factors and provide users and agents with additional capabilities such as communication and check-in/check-out features.

### CROSS-REFERENCE TO RELATED APPLICATION(S)

This application claims priority under 35 U.S.C. §119(e) of the U.S. Provisional Patent Application Ser. No. 62/379,685, filed Aug. 25, 2016 and titled, “SEARCH WITH HOME TOUR NAVIGATION,” which is hereby incorporated by reference in its entirety for all purposes.

### FIELD OF THE INVENTION

The present invention is in the technical field of navigation. More particularly, the present invention is in the technical field of navigation of real estate.

### BACKGROUND OF THE INVENTION

GPS navigation technology has advanced over the years. There is even crowd-sourced traffic information integrated in navigation apps such as Waze to assist a user to reach her location in the fastest time based on traffic conditions.

### SUMMARY OF THE INVENTION

A home tour navigation implementation generates a new user experience by integrating real estate search and the generation of a home tour of which is a series of homes that a user will visit. The home tour navigation implementation lists the properties by address, but also brings in the digital listing information so the user is able to view the details and imagery of a property before entering. The home tour navigation implementation allows for communication between agent and client. The home tour navigation implementation allows programmatic check in and check out so an agent has an idea of how long a client spent touring a property.

### BRIEF DESCRIPTION OF THE DRAWINGS

FIG. 1 illustrates a flowchart of a method of implementing home tour navigation according to some embodiments.

FIG. 2 illustrates a block diagram of an exemplary computing device configured for implementing the home tour navigation method according to some embodiments.

FIG. 3 illustrates a network of devices for implementing the home tour navigation method according to some embodiments.

FIG. 4 illustrates an exemplary route based on the home tour navigation method according to some embodiments.

FIG. 5 illustrates multiple exemplary routes based on the home tour navigation method according to some embodiments.

### DETAILED DESCRIPTION OF THE INVENTION

A home tour navigation implementation is an ecosystem of property listings for sale. The ecosystem of listings is able to be a private network of agents where the agent invites her clients. The ecosystem of listings is able to be public or consumer-facing. A user is able to search the ecosystem on a desktop or mobile web browser or a native app. In some embodiments, the desktop tour search is integrated with a native app. A user selects real estate properties (locations), and these selected listings are archived (listed) onto a GPS navigation application (“app”) as a bundle of properties that are routed into a tour. The app groups the list of properties in an order that represents the shortest drive time and displays this time to the viewer. The user is able to shuffle properties, drive time is recalculated and a new time is displayed. As the user drives from property to property, they are alerted when there is another property within the vicinity for sale or open house.

The properties are listed by address and include at least one more of the following items: images, video, 3D images, 3D video, virtual tour, map, property details or information about the listing information, links to relevant information (e.g., property analytics, historical information, trending information) and/or any other information/content. Each property is able to be expanded to view the aforementioned information. For example, selecting a property expands the property to a full screen view with the property details. In some embodiments, the property information is displayed in a page flipping book format as described in U.S. patent application Ser. No 14/634,595, filed Feb. 27, 2015 and titled, “COMMUNITY-POWERED SHARED REVENUE PROGRAM,” which is hereby incorporated by reference in its entirety for all purposes. The user is able to write notes for each property. Chatting is able to be implemented (e.g., a user is able to send an instant message to the user's agent or the listing agent or either agent is able to send an instant message to the user). For example, the user may be near a property and send an instant message (or any other communication) to the listing agent of a property to view the property or ask questions before going into the house. Similarly, an agent may notice that a user is near the property, and the agent is able to send a message to the user to entice the user to visit the property. An open house agent is able to be notified when person gets near the open house, (e.g., text on phone Mr. Smith is approaching). For example, the system (e.g., implemented on a server) and/or the agent's device is able to track and/or detect the user's device's proximity to a property and/or the agent's device, and when the user device is within a specified distance, an alert is triggered for the agent. An agent is able to receive a “check-in” and/or “check-out” alert when their clients arrive and leave a property. The check-in and check-out is also able to indicate how much time the user spent viewing a property. For example, the system monitors how long the user device is at a location. In another example, using Near Field Communication (or any other wireless implementation), the agent device detects the user device within a specified distance (e.g., a radius approximately equal to the size of the property) and records the amount of time the user device is within the specified distance. The user device is able to similarly track how long it is within the specified distance of the agent device or specified property. In some embodiments, the agent or user device sends the tracking information to a server or other device. The tracking/time information is then able to be used for further analysis.

A user is able to shuffle properties, and the drive time is recalculated. For example, if a user wants to view a specific property first (even though it may not be the most efficient), the user is able to indicate that, and the route is recalculated. A notification option for alerts when a user/driver is near another home for sale is able to be implemented. A user is able select a button to “switch” a route, then resume the tour after switching. In some embodiments, how busy homes are (e.g., based on # of people checked in or other data) is determined and factored in when determining the route and time. Determining how busy a home is able to be implemented in any manner such as the agent device calculating the number of user devices within a specified proximity, an agent device positioned near the door to automatically detect people entering and exiting the property (e.g., by image capture and/or motion sensor), the agent manually upticking/downticking a count as people enter/exit the property, or any other manner. The route and drive time are calculated based on an algorithm of time and location. The route and drive time are able be calculated based on crowd-sourced information (e.g., traffic information).

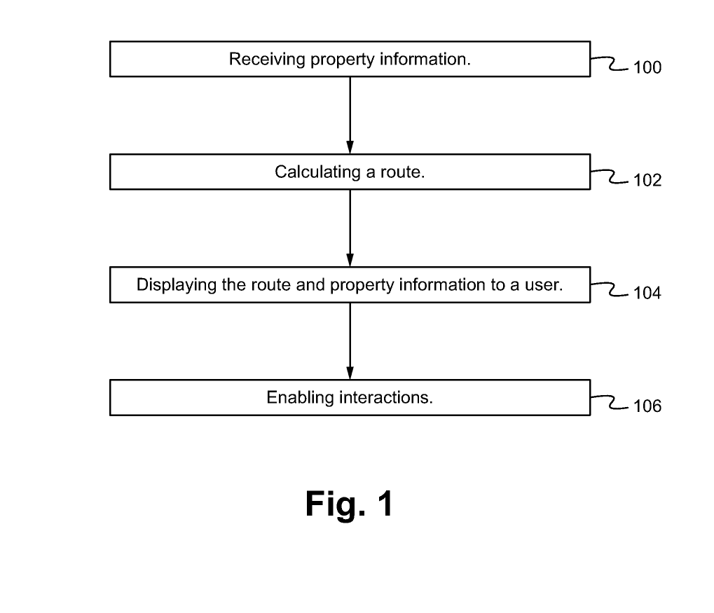

FIG. 1 illustrates a flowchart of a method of implementing home tour navigation according to some embodiments. In the step 100, property information is received. In some embodiments, the property information is manually provided by a user (e.g., by inputting an address, or selecting an address/icon such as viewing a map and clicking on each property that the user wants to visit). Similarly, a buyer's agent for the user is able to generate a route and provide it to the user (e.g., the agent inputs recommended addresses, and the system generates a route). In some embodiments, the property information is automatically determined by a device. For example, a user provides property criteria (e.g., 3 bedrooms, 2 baths, 2000 sq ft, San Francisco, under $3M), and the device determines which properties meet the specified criteria. In some embodiments, a mixture of both is implemented, such as automatically determining matching properties and enabling a user to de-select properties that the user does not want to visit.

In the step 102, a route is calculated to visit the determined/selected properties. The route/time calculation is able to analyze any factors such as the user's current position, traffic information/conditions, open house traffic (e.g., number of people in an open house), and/or listing/buyer agent availability and/or location, and/or historic user information (e.g., the system tracks how long a user spends at each open house, then computes an average or median time for each open house and uses the computed time for future time projections, where the tracking and computed times are continuously updated). The traffic information and the open house traffic information could be based on crowd-sourced information such as users indicating how the traffic on the roads is, and users checking in/out of an open house. The route calculation is also able to factor in open house dates/times, for example, although House X is closer, the open house is not until 1:30, while the open house for House Y is 1:00, so House Y is first on the route. Furthering the idea of the open house times, if a user's search determines 10 houses to view, the route calculator is also able to determine how much time is able to be spent at each house to ensure each house is visited. For example, for the 10 houses, instead of being able to visit each one for 30 minutes, the user may only have 10 minutes per house based on the driving times and other information. The method is also able to factor in that some houses may be open houses on multiple days, and prioritize houses that only have one open house first while saving other houses for a second day, if there is not enough time to see all of the houses on the first day. The route and time calculation is also able to utilize mapping criteria as well such as shortest mileage route, shortest time route, scenic route, avoiding freeways and/or any other mapping features. In some embodiments, the user is able to specify an order or order factors for the route. For example, instead of simply viewing the houses in the shortest order, the user wants to view the houses in order based on house prices with the most expensive house last or the largest house last. The user is able to specify a house's position in the order (e.g., visit House X last), and the remaining portion of the route is calculated with this aspect factored in.

In the step 104, the route and property information are displayed to the user. The route is able to be displayed on the user's phone (or other computing device such as tablet, personal computer, car computer/dashboard display). The route is updated as the user moves and as other factors change. For example, if traffic changes, the route may be recalculated and modified. In addition to displaying the route to the user, property information is displayed to the user. For example, images, video, 3D images, 3D video, virtual tour, map, property details or information about the listing information, links to relevant information (e.g., property analytics, historical information, trending information) and/or any other information/content are displayed. In some embodiments, the property information is displayed automatically when a user's GPS location is determined within a specified range of the property. For example, when a user's phone is detected within 1 mile of the next property on the route, the details of the property are automatically displayed. In some embodiments, additional information such as disclosures, inspections, and/or any other relevant information for purchasing the property is automatically downloaded at some point (e.g., when in a designated range or when a property is added to a route). In some embodiments, the additional information is pre-fetched or cached to expedite the accessibility of the data. For example, since real estate is generally local, the additional information is stored on a server closest to the property address. In another example, after a user performs a search, any additional information related to the properties that result from the search is pre-fetched even before the user actually selects a property. In another example, the pre-fetching is implemented to ensure that the user device receives the additional information before arriving at the property. Furthering the example, pre-fetching content is synchronized with the routing system to ensure the user device receives the additional information before arriving at the property. For example, if the routing system has the user going to House A first, House B second, and House C third, then the additional information for House A is pre-fetched first, then the additional information for House B and finally House C.

In the step 106, interactions are enabled. Interactions involve communications between users and agents. For example, users and agents are able to chat, send emails, make phone calls, communicate via social networking and/or communicate in any other manner through the app. Users are able to check-in and check-out of properties (e.g., open houses), so that the buyer's agent and/or the listing agent receives the check in/out information. In some embodiments, the interactions affect the route calculations. For example, in some embodiments, the home tour navigation app shows a user's current location to listing agents in a designated area or in an area proximate to the user's current location. A listing agent is able to contact a user. In some embodiments, the listing agent is able to view the user's scheduled route including the properties on the route. In an example, the listing agent is able to send a message to the user to come to her open house. The user is able to accept or decline, and the route is able to be recalculated. In some embodiments, users are able to select what others are able to view or not view (e.g., user does not want anyone else viewing her route, properties or current location). The user is able to take notes using the app, such as by typing/touching/speaking rating information, “like/dislike”, favorites, and/or any other notes via any input mechanism.

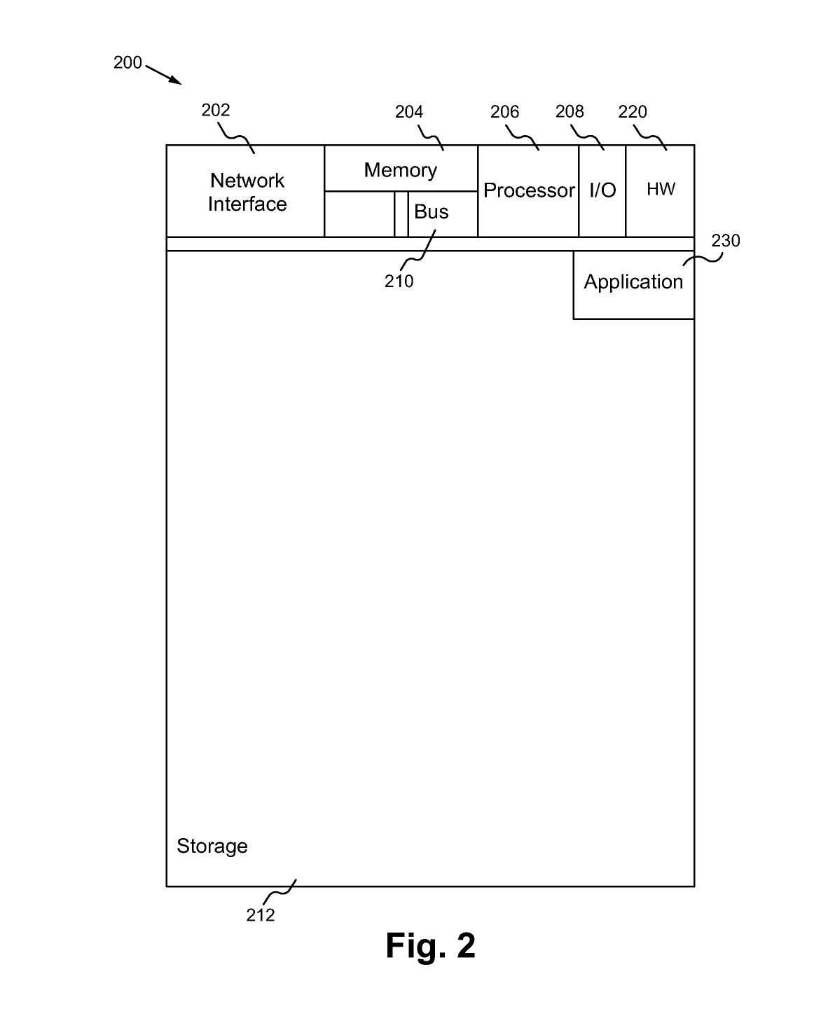

FIG. 2 illustrates a block diagram of an exemplary computing device configured for implementing the home tour navigation method according to some embodiments. The computing device 200 is able to be used to acquire, store, compute, process, communicate and/or display information. In general, a hardware structure suitable for implementing the computing device 200 includes a network interface 202, a memory 204, a processor 206, I/O device(s) 208, a bus 210 and a storage device 212. The choice of processor is not critical as long as a suitable processor with sufficient speed is chosen. The memory 204 is able to be any conventional computer memory known in the art. The storage device 212 is able to include a hard drive, CDROM, CDRW, DVD, DVDRW, High Definition disc/drive, ultra-HD drive, flash memory card or any other storage device. The computing device 200 is able to include one or more network interfaces 202. An example of a network interface includes a network card connected to an Ethernet or other type of LAN. The I/O device(s) 208 are able to include one or more of the following: keyboard, mouse, monitor, screen, printer, modem, touchscreen, button interface and other devices. Home tour navigation application(s) 230 used to perform the home tour navigation method are likely to be stored in the storage device 212 and memory 204 and processed as applications are typically processed. More or fewer components shown in FIG. 2 are able to be included in the computing device 200. In some embodiments, home tour navigation hardware 220 is included. Although the computing device 200 in FIG. 2 includes applications 230 and hardware 220 for the home tour navigation method, the home tour navigation method is able to be implemented on a computing device in hardware, firmware, software or any combination thereof. For example, in some embodiments, the home tour navigation applications 230 are programmed in a memory and executed using a processor. In another example, in some embodiments, the home tour navigation hardware 220 is programmed hardware logic including gates specifically designed to implement the home tour navigation method.

In some embodiments, the home tour navigation application(s) 230 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle device or any other suitable computing device.

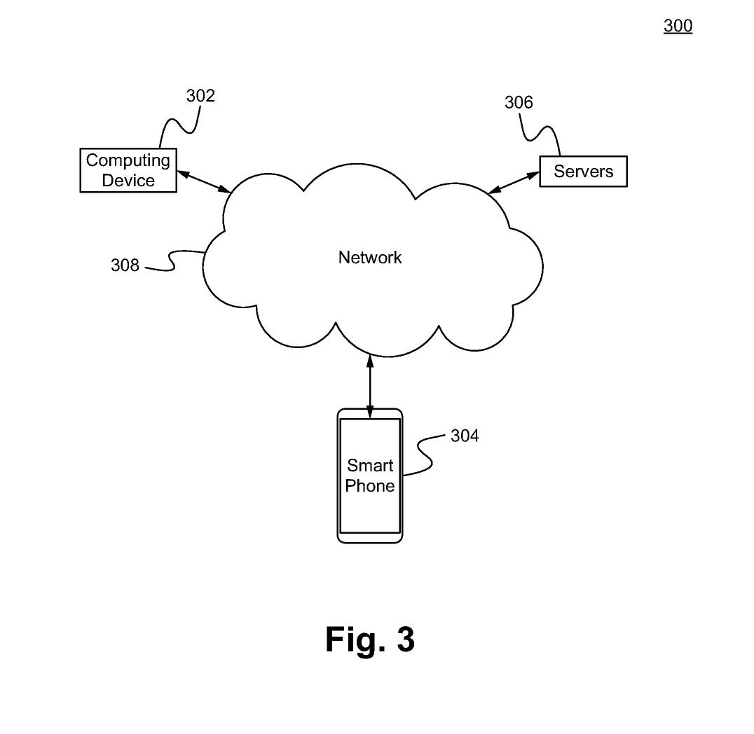

FIG. 3 illustrates a network of devices for implementing the home tour navigation method according to some embodiments. The network of devices 300 is able to include any number of devices. For example, the network of devices 300 includes a computing device 302, a smart phone 304, one or more servers 306 and a network 308. The devices are able to communicate through a network 310 such as the Internet or directly to each other. A user is able to use the computing device 302, the smart phone 304 and/or another device to perform tasks such as sending/receiving information (e.g., regarding property selections), displaying route information and/or any other tasks. The one or more servers 306 are used to calculate route information and perform other tasks.

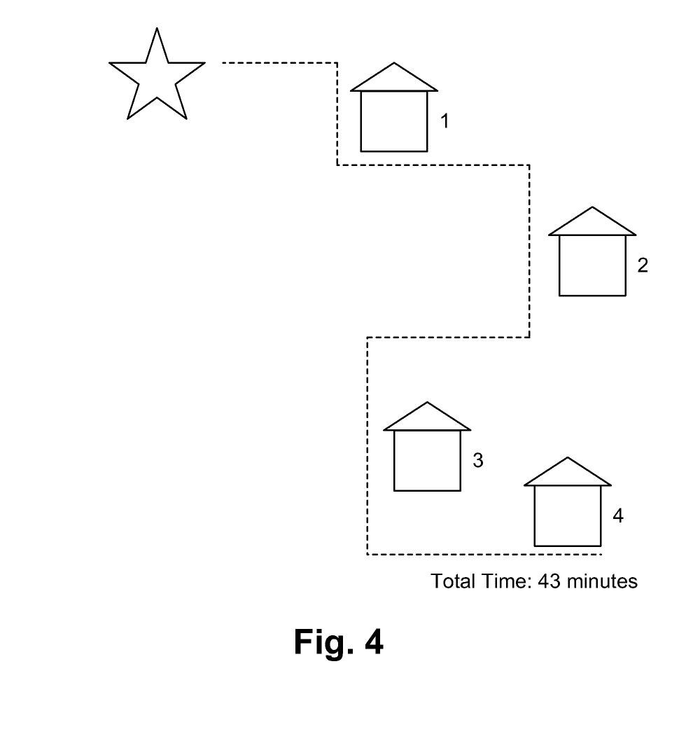

FIG. 4 illustrates an exemplary route based on the home tour navigation method according to some embodiments. A user's current position is represented by a star or any other representation. The home tour navigation method utilizes mapping information (e.g., street distances, traffic data, address information) to determine a shortest route (or other specified route) based on the determined/selected properties. As shown, the route takes the user to the first house, second house, third house and fourth house. Without the home tour navigation method, the user may inefficiently go to the second house and third house only to backtrack to the first house and then go to the fourth house. Significant time savings are possible using the home tour navigation method. As described herein, the route is able to be modified based on other factors such as the user specifying a certain order or a prioritized property, open house times, agent availability and/or other factors. In some embodiments, the time of the route is displayed.

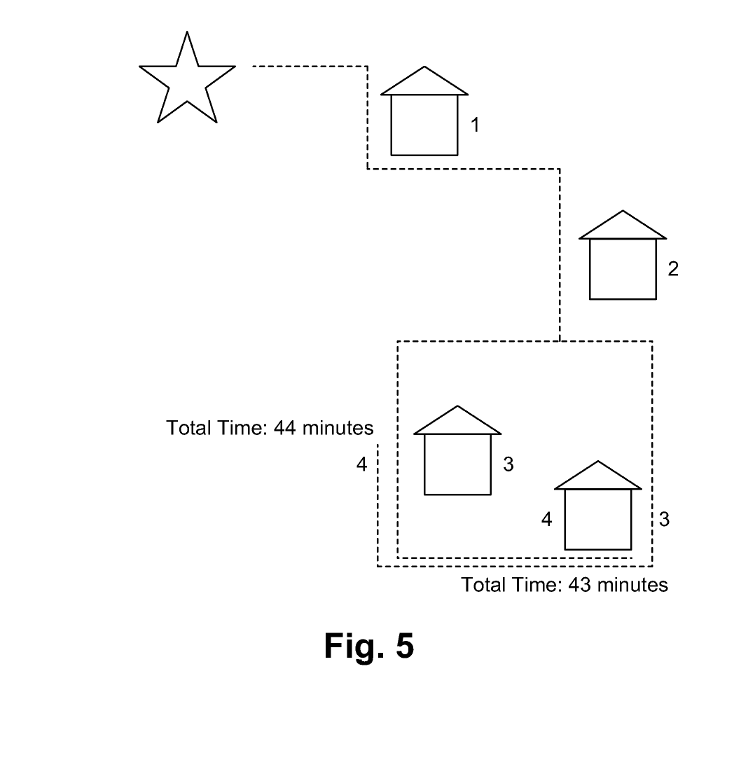

FIG. 5 illustrates multiple exemplary routes based on the home tour navigation method according to some embodiments. Similar to FIG. 4, a user's current position is represented by a star or any other representation. The home tour navigation method utilizes mapping information (e.g., street distances, traffic data, address information) to determine shortest routes (or other specified routes) based on the determined/selected properties. Instead of only providing a shortest route, multiple routes are displayed, so the user is able to select a route. For example, routes may be similar in time but would allow the user to see the houses in a different order. Furthering the example, the user may prefer to see the third house before the fourth house, and by providing multiple routes, the user is able to select the desired route. As described herein, the route is able to be modified based on other factors such as the user specifying a certain order or a prioritized property, open house times, agent availability and/or other factors. In some embodiments, the time of the routes are displayed.

To utilize the home tour navigation system, a user (e.g., agent or purchaser/seller) selects or receives property information (e.g., a list of properties available to purchase). After receiving the property information and/or making selections, a touring schedule is generated based on many factors as described herein such as property locations and traffic, which is able to guide and assist a user in navigating properties for purchase. In addition, the users are able to communicate using the system and/or perform other tasks such as sending documents to one another.

In operation, a user is provided informational and technological assistance in the home purchasing process. Assistance includes optimizing navigation between properties by analyzing a variety of data points. Additionally, information is able to be cached and/or pre-fetched based on a property location and/or a user location which improves network efficiency by storing the data nearer the recipient and preemptively acquiring the data.

In some embodiments, the home tour navigation system is implemented using an object-oriented programming language. For example, a program includes house/property objects with many different attributes such as size, address/location, number of beds, number of bathrooms, price, lot size, and/or any other information. The objects are then able to be managed similar to physical objects such as by placing them on a map or selecting one or more of them to view the information and/or calculate distance information between them.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

We claim:

1. A method programmed in a non-transitory memory of a device, the method comprising:
receiving input information for one or more properties;
calculating a route based on the input information;
displaying the route on the device; and
enabling interactions.

2. The method of claim 1 further comprising alerting a user when there is another property within a user's vicinity for sale.

3. The method of claim 1 further comprising displaying images, video, 3D images, 3D video, virtual tour, map, property details or information about the listing information, or links to relevant information for the one or more properties.

4. The method of claim 4 wherein displaying the images includes providing a page flipping book.

5. The method of claim 1 wherein enabling interactions includes enabling communication between a user and other users, wherein communication includes at least one of chatting, phone calls and email.

6. The method of claim 1 wherein enabling interactions includes providing a “check-in” and/or “check-out” alert when a user arrives and leaves a property.

7. The method of claim 1 further comprising providing a notification alert when a user is near a home for sale.

8. The method of claim 1 wherein the input information is entered manually.

9. The method of claim 1 wherein the input information is determined automatically.

10. The method of claim 1 wherein calculating the route utilizes factors including: a user's current position, traffic information/conditions, open house traffic, or listing/buyer agent availability or location.

11. The method of claim 10 wherein the traffic information and the open house traffic information is based on crowd-sourced information such as users indicating how the traffic on the roads is, and users checking in/out of an open house.

12. The method of claim 1 wherein calculating the route utilizes mapping criteria such as shortest mileage route, shortest time route, scenic route, or avoiding freeways.

13. The method of claim 1 wherein the device is a tablet, personal computer, or car computer/dashboard display.

14. The method of claim 1 further comprising when a user's phone is detected within a specified distance of a next property on the route, details of the property are automatically displayed.

15. A device comprising:
a non-transitory memory configured for storing an application, the application configured for:
receiving input information for one or more properties;
calculating a route based on the input information;
displaying the route on the device; and
enabling interactions; and
a processor configured for processing the application.

16. The device of claim 15 wherein the application is further for alerting a user when there is another property within a user's vicinity for sale.

17. The device of claim 15 wherein the application is further for displaying images, video, 3D images, 3D video, virtual tour, map, property details or information about the listing information, or links to relevant information for the one or more properties.

18. The device of claim 17 wherein displaying the images includes providing a page flipping book.

19. The device of claim 15 wherein enabling interactions includes enabling communication between a user and other users, wherein communication includes at least one of chatting, phone calls and email.

20. The device of claim 15 wherein enabling interactions includes providing a “check-in” and/or “check-out” alert when a user arrives and leaves a property.

21. The device of claim 15 further comprising providing a notification alert when a user is near a home for sale.

22. The device of claim 15 wherein the input information is entered manually.

23. The device of claim 15 wherein the input information is determined automatically.

24. The device of claim 15 wherein calculating the route utilizes factors including: a user's current position, traffic information/conditions, open house traffic, or listing/buyer agent availability or location.

25. The device of claim 24 wherein the traffic information and the open house traffic information is based on crowd-sourced information such as users indicating how the traffic on the roads is, and users checking in/out of an open house.

26. The device of claim 15 wherein calculating the route utilizes mapping criteria such as shortest mileage route, shortest time route, scenic route, avoiding freeways and/or any other mapping features.

27. The device of claim 15 wherein the device is a tablet, personal computer, or car computer/dashboard display.

28. The device of claim 15 further comprising when a user's phone is detected within a specified distance of a next property on the route, details of the property are automatically displayed.

29. A server device comprising:
a non-transitory memory configured for storing an application, the application configured for:
calculating a route based on input information;
sending the route to a user device; and
enabling interactions between user devices; and
a processor configured for processing the application.

30. The server device of claim 29 wherein the server device is located proximate to a property included in the input information.

31. The server device of claim 29 wherein the server device preemptively sends property information to the user device when the user device is within a specified distance of a property.

32. The server device of claim 29 wherein enabling interactions includes enabling communication between the user devices, wherein communication includes at least one of chatting, phone calls and email.

33. The server device of claim 29 wherein enabling interactions includes providing a “check-in” and/or “check-out” alert when a user arrives and leaves a property.

34. The server device of claim 29 wherein the application is further configured for providing a notification alert when a user is near a home for sale.

35. The server device of claim 29 wherein calculating the route utilizes factors including: a user's current position, traffic information/conditions, open house traffic, or listing/buyer agent availability or location.
